(19) United States
(12) Patent Application Publication
(10) Pub. No.: US 2004/0010798 A1
(43) Pub. Date: Jan. 15, 2004

(54) Apparatus and method for logging television viewing patterns for guardian review

(75) Inventors: Doreen Galli, Smyrna, GA (US); Rick Allen Hamilton II, Charlottesville, VA (US); Harry Schatz, McLean, VA (US)

Correspondence Address: Rudolf O. Siegesmund, Suite 2000, 4627 N. Central Expressway, Dallas, TX, 75205-4017, US

(73) Assignee: International Business Machines Corporation, Armonk, NY

(21) Appl. No.: 10/195,162

(22) Filed: Jul. 11, 2002

(51) Int. Cl. H04N 7/16; H04H 9/00; H04N 7/00; H04N 11/00

(52) U.S. Cl. 725/28; 348/461; 725/9; 725/20; 725/29; 725/25

(57) ABSTRACT

A guardian review system is disclosed which monitors the television programming that a child watches and to report back to the parent. The hardware consists of a logical unit which is used to monitor the television programming. The software is divided into two programs: the monitor program and the report program. The monitor program analyzes the closed captioning signal, the audio signal, the title, and content ratings of the television programming to determine if the television programming contains any of the offensive items specified by the parent. The monitor program creates data of the offensive language viewed by the child and sends the data to the report program. The reporting program receives criteria from the parent such as time, channel, duration, rating, and content of a television program. The report program can operate either on the television or on an external computing device, such as the parent's personal computer.

### CROSS-REFERENCE TO RELATED APPLICATIONS

The present invention is related to application Ser. No. 10/105,124 “Apparatus and Method of Searching for Desired Television Content” filed Mar. 21, 2002, which is incorporated herein by reference.

### FIELD OF THE INVENTION

The invention relates to an apparatus and method monitoring and recording television viewing patterns for guardian review.

### BACKGROUND OF THE INVENTION

Television has long been considered to have a significant influence on children. Television programming offers some fare that is only suitable for “mature” audiences. Parents are not always able to know what their children are watching and typically do not have the time to ensure that their child is watching only what the patent considers to be suitable.

U.S. Pat. No. 6,331,877, “Electronic Television Program Guide Schedule System and Method,” discloses a method of blocking undesired television programming. The '877 patent uses an on-screen menu to block particular television shows according to the channel they are on, their Motion Picture Association of America (MPAA) rating, or their parental guidance indicators (i.e. violence, nudity, adult situations, etc.). However, a need exists beyond the '877 patent for a method that allows a parent to review the television programming that has actually been viewed when the parent is not present.

U.S. Pat. No. 6,321,381, “Apparatus and Method for Improved Parental Control of Television Use,” also discloses a method of blocking undesired television programming. The '381 patent uses a parental ID and an on-screen menu to block specific television programs. However, a need exists beyond the '381 patent for a method that allows a parent to review the television programming that has actually been viewed in their absence.

U.S. Pat. No. 6,094,194, “Apparatus and Method of Providing a Controller for Selective Blocking of Cable Television Programming,” discloses a method for blocking undesired television content. In the '194 patent, the cable box connected to the television is locked inside the invention. The user then interfaces with the cable box through the invention, so that the user can block unwanted television programming. However, what is needed beyond the '194 patent is a method of monitoring the programming actually viewed and that is not dependent on the use of a cable box.

U.S. Pat. No. 6,025,869, “Video Viewing Supervision System,” discloses a television programming blocking apparatus that uses an on-screen channel/time matrix to block the television programs. However, a need exists beyond the '869 patent for a method that allows a parent to review the television programming that has actually been viewed in their absence.

U.S. Pat. No. 5,382,983, “Apparatus and Method for Total Parental Control of Television Use,” also discloses a method of blocking television programming by use of an on-screen menu. Again, a need exists beyond the '983 patent for a method that allows a parent to review the television programming that has actually been viewed when the parent is not present.

More recently, the V-Chip has gained popularity as an effective method of blocking television programming based on MPAA ratings, age restrictions, or content. However, the v-chip is only a method of blocking either channels or programs from viewing; no logging or recording mechanism is provided so that the parent can review what programs the children have selected and watched. Moreover, certain television-viewing habits which may be otherwise benign would not be blocked by the v-chip but could be important to the parent. For example, viewing an innocuous program at 3:00 a.m. (when a child should be asleep), or any viewing at all, during a period of punishment when television viewing privileges have been taken away, would not be recorded by the prior art mechanisms described above or by the V-Chip. The V-Chip, and indeed all the prior art that address the problem of restricted viewing, focus on the act of how to stop the programming from appearing on the television screen. What is needed is an invention that takes a different approach to parental supervision than that taken by the v-chip and the prior art. Whereas the v-chip and the prior art attempt to prevent the child from viewing the unwanted programs, a need exists for a “trust, but verify” method of parenting that allows parents to trust their children with unrestricted access, but that also allows them to verify that their trust is warranted.

Application Ser. No. 10/105,124 (the '124 application) discloses an apparatus and method for allowing a user to search for specific content across many television channels in order to locate desirable television shows related to the searched content. This television viewing mechanism is based upon real-time network television broadcasting of shows in progress which provide audio captioning, as opposed to cable provider television folders, movie indexed shows, guides, or live audio feeds. The fundamental logical manipulations occur at the user's location either in the tuning unit within the television or in a set-top box (the logical unit). These multiplexed cable signals flow thorough the logical unit which buffers text associated with the voice stream of each station. This can be done via the pre-encoded closed-captioning signal or through the real-time voice translation (e.g. through ViaVoice or other well-known technologies) within the logical unit. Thus, the '124 application discloses a method of analyzing closed captioned signals and audio signals in a video feed.

What is needed beyond both the prior art and the '124 application is an invention to provide parents the means of automatically capturing the specific programming viewed by a monitored television. A further need is for a means of monitoring the closed captioning of a program for offensive language. A need exists for a way to provide the parent with an e-mail or locally-stored report when the programming meets certain capturing parameters, such as duration of programming, type of programming as determined by the television industry's self-imposed rating system, time of day reporting, or language/profanity monitoring.

### SUMMARY OF THE INVENTION

The present invention is a guardian review system combining software and hardware to monitor the television programming that a child watches and to report the result of the monitoring back to the parent. The hardware consists of a logical unit which is used to monitor the television programming. The software is divided into two programs: the monitor program and the report program. The guardian review device does not block television programming, but serves to monitor and report to the parent what the child has been watching. The monitor program analyzes the closed captioning signal, the audio signal, the title, and content ratings of the television programming to determine if the television programming contains any of the offensive items specified by the parent. The monitor program creates data of the offensive language viewed by the child and sends the data to the report program. The reporting program receives criteria from the parent such as time, channel, duration, rating, and content of a television program. In addition, the parent can select a report of all of the television that the child has watched or a report of just the television programming that contained offensive content as defined by the specified criteria. The parent can also specify the frequency with which the report is provided. In the report program, the parent may also view reports and add new terms to the content dictionary containing a list of offensive terms specified by the parent. The content dictionary can be expanded by direct input or by downloading newly identified terms. The report program can operate either on the television or on an external computing device, such as the parent's personal computer. The parent can then review the report either on the television or on a PC, depending on where the report program is implemented.

### BRIEF DESCRIPTION OF THE DRAWINGS

FIG. 1 is an illustration of the invention interacting with a cable provider and a television set.

FIG. 2 is a depiction of the data processing system contained within the logical unit.

FIG. 3 is a depiction of the logic of the report program of the present invention.

FIG. 4 is a depiction of the logic of the monitor program of the present invention.

### DETAILED DESCRIPTION OF THE PREFERRED EMBODIMENT

The term “parent” as used herein means the person who specifies the criteria in the report program of the present invention. This person is typically the parent or guardian of a child but is not limited as such. The term “child” as used herein means a person who watches television. The child is typically an offspring of the parent who is restricted form viewing a certain type of programming by the parent. The term “multiplex” as used herein means the process of funneling several different streams of data over a common communications line. The term “cable provider” as used herein means a company which provides television service to multiple users and includes satellite television services.

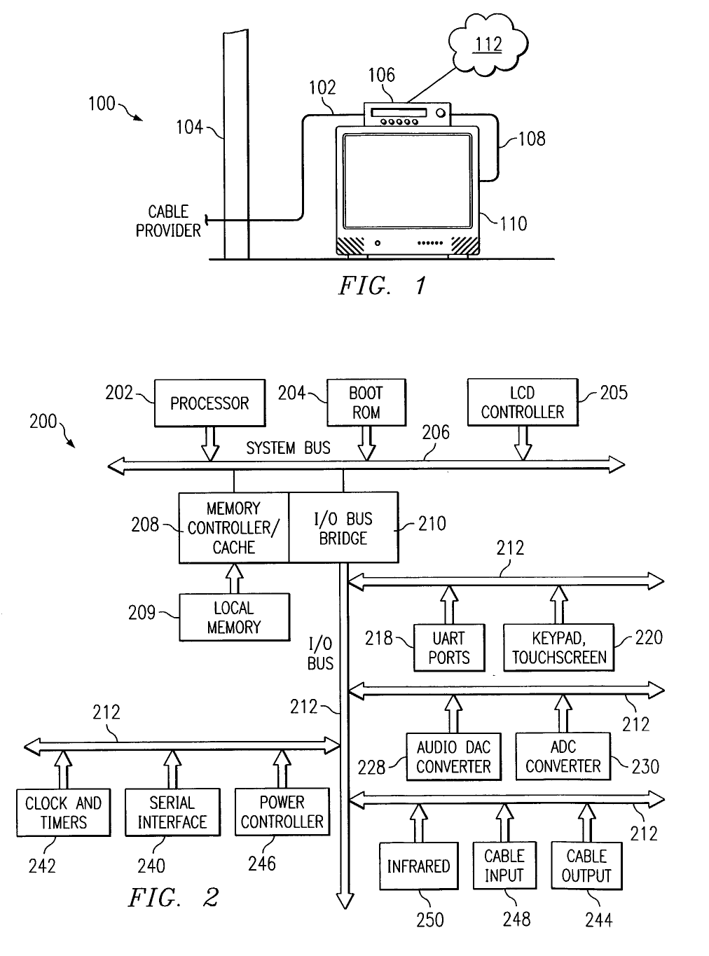

FIG. 1 is an illustration of the guardian review system 100 interacting with a cable provider and a television set. The cable provider (not shown) provides a television signal through a coaxial cable 102 that runs through the user's wall 104 and into the logical unit 106. Monitor program 400 operates within logical unit 106 to monitor the cable signal as described below. Logical unit 106 is capable of displaying information on television 110 via television connection 108 or can distribute information via the internet 112. Logical unit 106 can be connected to the internet via coaxial cable 102 or through another external connection. Those skilled in the art are aware of how to configure an electronic device with an internet connection via a coaxial cable (i.e. a cable modem) or through another external connection (i.e. DSL, dialup, etc.). Logical unit 106 may be a device external to television 110 or may be located within television 110. Alternatively, logical unit 106 may be placed at the same location as the cable provider such that it is unnecessary to have logical unit 106 at the user's location.

FIG. 2 is a depiction of the data processing system 200 contained within logical unit 106 (See FIG. 1). Data processing system 200 comprises processor 202, boot ram 204, and LCD controller 205 electrically coupled to system bus 206. Also coupled to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted. Peripheral components are connected via I/O bus 212. Typical peripheral components include Universal Asynchronous Receiver Transmitter (UART) 218, a keypad or touch screen 220, digital-to-analog converters 228, analog-to-digital converters 230, serial interface controller 240, clocks and timers 242, cable output to the television 244, power controller 246, cable input from the cable provider 248, and infrared ports 250. Those skilled in the art will appreciate the depiction of data processing system 200 in FIG. 2 is exemplary and is not intended as an architectural limitation of the present invention. Data processing system 200 may be a separate single controller.

Within memory 209 of logical unit 106 are two programs, report program 300 and monitor program 400, which operate together to comprise guardian review system 100. Alternatively, report program 300 can be located in the memory of an external computer, such as the parent's PC. In that case report program 300 communicates with monitor program 400 and logical unit 106 via internet 112, cable connection 102, or any other means as determined by those skilled in the art.

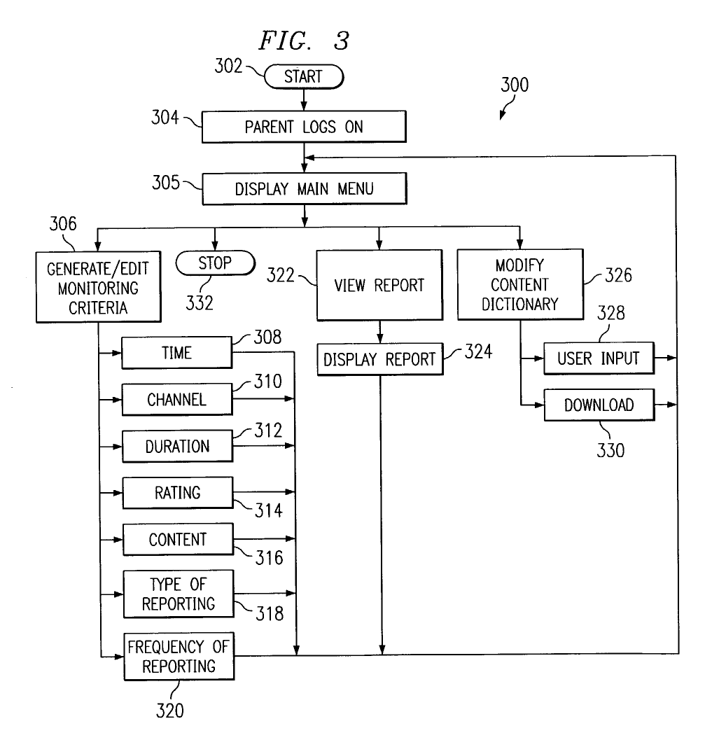

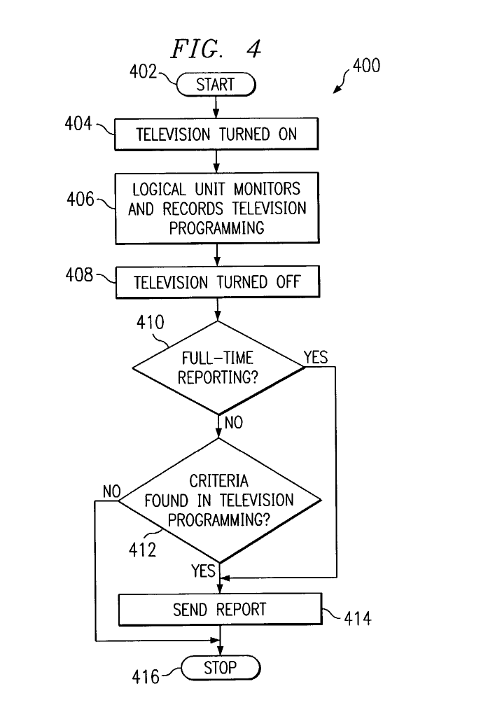

FIG. 3 is a flowchart of report program 300. Report program 300 starts (302) when the parent logs on to report program 300 and enters a parental password (304). When the parent logs on, she is presented with the main menu 305 containing four options: generate/edit the report criteria, view the report, modify the content dictionary, or end report program 300 (305). Each of these options is discussed in detail below.

The first option the parent has under main menu 305 is to generate or edit the report criteria (306). If the parent has never before specified any report criteria under step 306, then the parent generates new criteria for the report in this step. If the parent has previously created a report, then the parent will edit the criteria already entered in this step. When the parent selects option 306, a menu of seven options is presented which comprise the criteria for generating the report. The seven options are:

1. Time (308)—The parent can configure monitor program 400 to generate a report item when the child watches television at a time of day that the parent considers to be unacceptable. This is a useful option if the parent wishes to restrict the hours that the child watches television. A typical time criteria would be “generate a report item if the television is watched between 10 pm and 6 am.”

2. Channel (310)—The parent can configure monitor program 400 to generate a report item when the child watches a specific channel on the television that the parent considers to be unacceptable (i.e. Channel 4 or HBO). This is a useful setting when the parent wishes to restrict viewing of a single or a plurality of channels. Typical channel criteria would be “generate a report item if channel 4 is watched.”

3. Duration (312)—The parent can configure monitor program 400 to generate a report item when the child watches television for a length of time that the parent considers to be unacceptable. This can be in one of three formats: the length of the television program, the total time the television has been watched, or the aggregate time the television has been watched. For example, monitor program 400 can be configured to generate a report item when the child watches a show that is more than two hours long. This is the length of the television program. This is a useful setting when the parent wants to restrict movie watching but not necessarily the news or educational programming. Additionally, monitor program 400 can be configured to generate a report item of the total time the child watches a certain amount of television in one sitting. This is a useful setting when there are general restrictions on the number of hours the television may be watched in a single sitting, but not necessarily limiting the type of programming watched. Alternatively, monitor program 400 can be configured to generate a report item on the aggregate time the child watches television in a specified period of time (for example, a one week period). This is a useful setting when there are general restrictions on the number of hours the television may be watched in a given amount of time, but not necessarily limiting the type of programming watched. The three format options can be combined in one report request such as to “generate a report if the child watches a movie more than two hours long, watches more than two hours of television in one sitting, and/or watches more than ten hours of television in a week.”

There is also an option presented here in which the parent can disable the report item generation if the television program is viewed for a short amount of time. For example, the parent may not want monitor program 400 to generate a report item if the child is surfing through the channels and an offensive word is contained in a program as the child is going from one to another. A typical command under this option would be to “generate a report item only if the offensive program is viewed for more than three seconds.” This exception is applicable to all of the report criteria entered under step 306.

4. Rating (314)—The parent can configure monitor program 400 to generate a report item when the child watches a television program that is given a specific rating. There are at least three types of rating systems currently used in television programming. Movies are generally rated according to the Motion Picture Association of America (MPAA) standards and are given a rating of G, PG, PG-13, R, NC-17 and the like. Normal television programming is rated according to the Television Rating Code (TRC) which is mandated by 47 U.S.C §303. Additionally, many forms of programming are rated according to age restrictions (i.e. not recommended for audiences less than twelve years old). Moreover, many forms of programming are also rated according to a content index which appears at the beginning of the program (i.e. adult situations, violence, nudity, etc.). Under this option, the parent can have monitor program 400 generate a report item that is triggered by the child watching a program with any of these standardized ratings. Typical rating criteria would be to “generate a report item if any programs rated PG-13 or above are watched.” Also to “generate a report item if any programs with contain nudity or violence or are not recommended for audiences under twelve are watched.”

5. Content (316)—In addition to the conventional ratings under step 314, monitor program 400 continually analyzes the content of the current television program (as described below) for unacceptable content. The parent can configure monitor program 400 to generate a report item whenever monitor program 400 recognizes a specified word. In this option, the parent is presented with a content dictionary, which is a list of words that are offensive. The parent then highlights some or all of the words on the list and designates those words as criteria monitor program 400 uses to monitor the currently viewed television program. Alternatively, the parent can select an option which will generate a report item anytime that generally offensive language is contained in the television programming. The parent is also presented with an option to have monitor program 400 generate a report item anytime that specific titles of movies or television programs (i.e. “Sex in the City” or “Die Hard”) are watched.

6. Type of Reporting (318)—There are two types of reports available to the parent. First, the parent can select an option that will have monitor program 400 generate a report showing what channel and show was watched and what the general content of the programming was for the entire duration the television was turned on (full-time reporting). Alternatively, the parent can select an option to have monitor program 400 generate report items only when all or some of the criteria selected under step 306 are met. The parent is also presented with the option to temporarily stop the generation of reports here.

7. Frequency of Reporting (320)—Under this option, the parent specifies the frequency with which reports are generated. Monitor program 400 can generate reports every time the television is turned on, daily, weekly, monthly, or with any other frequency as determined by a person skilled in the art. The parent may also specify which day of the week and what time to deliver the reports (i.e. Monday at 9 am).

After any one of the seven options is selected under step 306, report program 300 returns to the main menu 305.

The second option that the parent has under the main menu 305 is to view a report (322). If this option is selected, report program 300 displays the report on a graphical user interface (either the television or the PC monitor). If multiple reports have been received, then the parent may be presented with a list of reports and the parent can select which report is desired. Report program 300 then returns to the main menu 305.

The third option that the parent has under main menu 305 is to modify the content dictionary used in step 316 (326). Here, the parent can add terms to the content dictionary by user input (328). Alternatively, the parent can download newly offensive language or other terms which the parent may want to monitor for other reasons (330). If logical unit 106 is connected to the internet 112, then terms may be downloaded via the internet 112. If logical unit 106 is not connected to the internet 112, then logical unit 106 can download the terms through serial interface 240, infrared port 250, or through any other input/output port through which logical unit 106 can receive information.

The fourth option the parent has under the main menu 305 is to end report program 300 (332). If the monitoring criteria have been generated or edited under step 306, then report program 300 sends then updated criteria to monitor program 400 when report program 300 ends. If both programs are implemented in logical unit 106, then the updating process is relatively simple and only involves the transfer of information from one memory compartment to another inside logical unit 106. If report program 300 is located on a PC or other device external to logical unit 106, then report program 300 sends the update through the internet or similar means used to connect report program 300 to logical unit 106.

FIG. 4 is a flowchart of monitor program 400. Monitor program 400 operates within logical unit 106 to analyze the television program that is being viewed by the child. Monitor program 400 starts (402) when the television is turned on (404). Alternatively, monitor program 400 can start whenever an electronic recording/playback device (i.e. a VCR or DVD player) or a video game platform (i.e. a PS2 or X-Box) is turned on. Present invention 100 is easily adaptable to gaming platforms since the video game feed goes through the television and the majority of video games now contain standardized ratings (i.e. violence, gore, and suggested age levels) similar to those used in television programming and movies. By starting whenever an electronic recording/playback device or video game platform is turned on, monitor program 400 can monitor not only the television programming but also movies, video games, and other media types and programs. Monitor program 400 can monitor what the electronic recording/playback device is recording from the television as well.

Monitor program 400 then monitors the television programming and either makes a record of all of the television programs watched, or itemizes those programs which are triggered by the criteria specified in report program 300 (406). Monitor program may use any method known to persons skilled in the art including but not limited to those methods disclosed in application Ser. No. 10/105,124. In monitoring the television programming, monitor program 400 compares the criteria specified in step 316 to the words contained in the closed captioning signal contained in the television program. Monitor program 400 also compares the audio signal to the criteria specified in step 316. Monitor program 400 also compares ratings of the program to the criteria specified in step 314 and the title of the program to the criteria specified in step 316. Monitor program 400 also compares the criteria specified in steps 308, 310 and 312 to those in the television program to see if the program has been restricted. If at step 318, the parent has specified full-time reporting, then monitor program 400 generates a report that lists the details of the program being watched and updates the list every time the program changes or the channel is changed. If at step 318 the parent specified that monitor program 400 should only generate a report whenever the program contains all or some of the specified criteria, then monitor program 400 only generates and updates the report when the program contains all or some of the specified criteria.

When the television is turned off (408), monitor program 400 makes a determination of whether the parent made a selection for full-time reporting in step 318 (410). If so, then monitor program 400 sends the report to report program 300 (414) and ends (416). If the parent did not specify full reporting, then monitor program 400 makes a determination of whether any of the specified criteria was present in the programming (412). If the programming did not contain any of the specified criteria, then monitor program 400 ends (416). Alternatively, monitor program 400 can send a report to report program 300 indicating that the programming did not contain any of the specified criteria before monitor program 400 ends. If at step 412 monitor program 400 determines that the programming contains some of the specified criteria, monitor program 400 sends a report to report program 300 indicating the programming which contained the specified criteria (414) and ends (416). Alternatively, monitor program 400 can send a report of all of the programming that the child viewed and flag the specific programs which contained the specified criteria. Additionally, if the parent has specified that the report is to be sent at a certain frequency in step 320 (i.e. weekly), at the time specified in step 320 monitor program compiles the reports and sends the compilation report to report program 300 at the specified day and time.

With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention. Additionally, the steps of the present invention need not be implemented in the order disclosed herein. The novel spirit of the present invention is still embodied by reordering or deleting some of the steps contained in this disclosure. The spirit of the invention is not meant to be limited in any way except by proper construction of the following claims.

What is claimed is:

1. A method comprising:
specifying a criterion;
monitoring a television by a logical unit for programming that contains said criterion;
reporting a result of said monitoring.

2. The method of claim 1 wherein said criterion is a limitation on the time said television may be watched.

3. The method of claim 1 wherein said criterion is a limitation on the duration said television may be watched.

4. The method of claim 1 wherein said criterion is a limitation on the rating of said television programming.

5. The method of claim 1 wherein said reporting is full-time reporting.

6. The method of claim 1 wherein said reporting only contains said content which contains said criterion.

7. The method of claim 1 wherein said criterion is a limitation on the content of said television programming.

8. The method of claim 7 wherein said content is contained in a content dictionary which may be expanded by parental input.

9. The method of claim 7 wherein said content is contained in a content dictionary which may be expanded by downloading additional content terms.

10. The method of claim 1 wherein said reporting is in the form of an electronic transmission to a personal computer.

11. The method of claim 1 wherein said monitoring further comprises analyzing a closed captioned signal in said television programming for terms that are restricted by the parent.

12. The method of claim 1 wherein said monitoring further comprises analyzing an audio signal in said television programming for terms that are restricted by the parent.

13. The method of claim 1 wherein said programming originates from a recoding/playback device.

14. The method of claim 1 wherein said programming originates from a video game platform.

15. A method for analyzing a video signal for offensive language using a logical unit comprising:
monitoring a television for programming that contains a criterion;
creating a report that is a record of said criterion containing programming; and
displaying said report.

16. The method of claim 15 wherein said report is record of all of the programs viewed on said television.

17. The method of claim 15 wherein said report is displayed on a personal computer.

18. The method of claim 15 wherein said monitoring further comprises analyzing a closed captioned signal in said television programming for terms that are restricted by the parent.

19. The method of claim 15 wherein said monitoring further comprises analyzing an audio signal in said television programming for terms that are restricted by the parent.

20. The method of claim 15 wherein said programming originates from a recoding/playback device.

21. The method of claim 15 wherein said programming originates from a video game platform.

22. An apparatus comprising:
a logical unit containing a memory and a processor;
a computer program stored in said memory;
wherein said computer program directs said processor to perform steps comprising:
accept a specification of a criterion;
monitor a television for programming that contains said criterion; and
report said programming.

23. The apparatus of claim 22 wherein said criterion is a limitation on the time said television may be watched.

24. The apparatus of claim 22 wherein said criterion is a limitation on the duration said television may be watched.

25. The apparatus of claim 22 wherein said criterion is a limitation on the rating of said television programming.

26. The apparatus of claim 22 wherein said reporting is full-time reporting.

27. The apparatus of claim 22 wherein said reporting only contains said content which contains said criterion.

28. The apparatus of claim 22 wherein said criterion is a limitation on the content of said television programming.

29. The apparatus of claim 28 wherein said content is contained in a content dictionary which may be expanded by parental input.

30. The apparatus of claim 28 wherein said content is contained in a content dictionary which may be expanded by downloading additional content terms.

31. The apparatus of claim 22 wherein said reporting is in the form of an electronic transmission to a personal computer.

32. The apparatus of claim 22 wherein said monitoring further comprises analyzing a closed captioned signal in said television programming for terms that are restricted by the parent.

33. The apparatus of claim 22 wherein said monitoring further comprises analyzing an audio signal in said television programming for terms that are restricted by the parent.

34. The apparatus of claim 22 wherein said programming originates from a recoding/playback device.

35. The apparatus of claim 22 wherein said programming originates from a video game platform.

36. An apparatus for analyzing a video signal for offensive language comprising:
a logical unit containing a memory and a processor;
a computer program stored in said memory;
wherein said computer program directs said processor to perform steps comprising:
monitor a television for programming that contains a criterion;
create a report that is a record of said criterion containing programming;
display said report to a parent; and
wherein said monitoring and said creating occurs within a logical unit.

37. The apparatus of claim 36 wherein said report is record of all of the programs viewed on said television.

38. The apparatus of claim 36 wherein said report is displayed on a personal computer.

39. The apparatus of claim 36 wherein said monitoring further comprises analyzing a closed captioned signal in said television programming for terms that are restricted by the parent.

40. The apparatus of claim 36 wherein said monitoring further comprises analyzing an audio signal in said television programming for terms that are restricted by the parent.

41. The apparatus of claim 36 wherein said programming originates from a recoding/playback device.

42. The apparatus of claim 36 wherein said programming originates from a video game platform.

43. An apparatus comprising:
means for specifying a criterion;
means for monitoring a television by a logical unit for programming that contains said criterion;
means for reporting a result of said monitoring.

44. The apparatus of claim 43 wherein said criterion is a limitation on the time said television may be watched.

45. The apparatus of claim 43 wherein said criterion is a limitation on the duration said television may be watched.

46. The apparatus of claim 43 wherein said criterion is a limitation on the rating of said television programming.

47. The apparatus of claim 43 wherein said reporting is full-time reporting.

48. The apparatus of claim 43 wherein said reporting only contains said content which contains said criterion.

49. The apparatus of claim 43 wherein said criterion is a limitation on the content of said television programming.

50. The apparatus of claim 49 wherein said content is contained in a content dictionary which may be expanded by parental input.

51. The apparatus of claim 49 wherein said content is contained in a content dictionary which may be expanded by downloading additional content terms.

52. The apparatus of claim 43 wherein said reporting is in the form of an electronic transmission to a personal computer.

53. The apparatus of claim 43 wherein said monitoring further comprises analyzing a closed captioned signal in said television programming for terms that are restricted by the parent.

54. The apparatus of claim 43 wherein said monitoring further comprises analyzing an audio signal in said television programming for terms that are restricted by the parent.

55. The apparatus of claim 43 wherein said programming originates from a recoding/playback device.

56. The apparatus of claim 43 wherein said programming originates from a video game platform.
